(19) United States
(12) Patent Application Publication
(10) Pub. No.: US 2004/0200106 A1
(43) Pub. Date: Oct. 14, 2004

(54) Personalized decorative ornaments and method for personalizing ornaments

(75) Inventor: Cory A. Campbell, Morris, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Tee Time Imports, Morris, IL

(21) Appl. No.: 10/409,885

(22) Filed: Apr. 9, 2003

(51) Int. Cl. G09F 3/10

(52) U.S. Cl. 40/638

(57) ABSTRACT

An ornament bearing a personalized message and method of making the same. The personalized message is applied to a label and the label is applied to a message surface on the ornament. The labels bearing personalized messages may be generated at the point-of-sale by the retailer, or by the purchaser after purchase. A computerized system may be used to generate the labels.

### FIELD OF THE INVENTION

The present invention is generally directed to decorative ornaments, and more particularly to personalized ornaments, and a method for making the same.

### BACKGROUND OF THE INVENTION

Ornaments have long been used by people to decorate homes, workplaces, retail establishments, and any place where decorative ornamentation is desired in general. Personalizing, or adding a message to an ornament increases its utility and desirability, because the buyer of the ornament can thus create an ornament for a particular occasion or moment in time. For example, the buyer may purchase an ornament intended to correspond to a particular year that it is first displayed, or with an appropriate message for an occasion or holiday. Similarly, a buyer wishing to give a decorative ornament as a gift to someone may wish the ornament to bear the recipient's name. Also, the members of a family or the staff of an office may wish to decorate with a series of similar ornaments, each including the name of a family or staff member. Other buyers may simply wish to add a personalized message to an ornament that they need immediately and do not wish to order and wait for.

Of course, it is also advantageous for retailers to supply the demand for such ornaments, for obvious reasons. However, it is difficult to efficiently forecast demand for particular messages or names. For example, in ordering and offering decorative ornaments personalized with a particular name, a retailer is not likely to accurately guess exactly the correct number of ornaments with that particular name that he will sell. As a result, he will either exceed or fall short of the actual demand for ornaments personalized with a particular name or message, thus incurring inventory storage or liquidation costs, or losing sales he otherwise would have made.

Similarly, a retailer may wish to offer purchasers ornaments including both “standard” holiday greetings or other options. In this case, it is even harder for a retailer to predict the exact number of ornaments with a particular greeting to order.

Thus, a need exists for a personalized decorative ornament and method of making the same, which allows a retailer to exactly provide for his customers' spontaneous demand for such ornaments in an efficient and cost-effective manner.

### SUMMARY OF THE INVENTION

The invention provides such a decorative ornament and a method for making the same. In one embodiment, a retailer offers an attractive ornament for sale. The ornament of this embodiment may include a message surface on which a personalized message may be displayed. The retailer may then enhance the ornament's attractiveness by adding a personalized message to the dedicated message surface in accordance with a customer's request.

In another embodiment, labels bearing a personalized message may be adhesively affixed to the dedicated message surface. In this embodiment, the label and the message surface may have the same shape, in order that the combined ornament and label provide an integrated, finished appearance. In another embodiment, the message-bearing labels may be affixed to ornaments without a dedicated message surface. Alternately, the printed labels may be of a particular color, or clear, to provide an attractive, finished appearance. Further, the retailer may have the capability to add any message the customer may desire to the ornament by generating a message-bearing label at the point of sale. According to another embodiment, a retailer may prepare ornaments bearing particular messages or names before they are offered for sale, in accordance with the latest indicators of demand. This allows the retailer to avoid placing larger orders than necessary, and to generate ornaments with personalized messages as needed, thus more readily responding to fluctuations in demand. As a result, the retailer's business is streamlined, and the retailer can thus avoid the costs associated with excess inventory and additional ornament-ordering procedures.

Still another embodiment of the invention may provide for a die-cut sheet of labels to which the retailer may apply personalized messages before affixing them to the ornaments. Further, a retailer may utilize a computerized system to prepare entire sheets of such labels, with identical or varied messages. Such a system may include a label printer, or other device for applying a personalized message to a label. In such an embodiment of the invention, a retailer may be provided with software package that is directed to preparing ornament labels on particular sheets of die-cut adhesive labels. Such a software-based system may also be sold as a kit to a purchaser, thus allowing the purchaser to generate, in the home of the purchaser, personalized or customized labels for ornaments designed for use with the kit.

### BRIEF DESCRIPTION OF THE DRAWINGS

FIG. 1 illustrates a front elevational view of an embodiment of the invention, in which a personalized message is applied to a label affixed to an ornament.

FIG. 2 illustrates a rear elevational view of the embodiment of FIG. 1.

FIG. 3 illustrates a front elevational view of another embodiment of the invention, in which a personalized message is applied directly to an ornament.

FIG. 4 illustrates a front elevational view of another embodiment of the invention, in which a personalized message is applied to a label affixed to an ornament.

FIG. 5 illustrates a rear elevational view of the embodiment of FIG. 4.

FIG. 6 illustrates a front elevational view of yet another embodiment of the invention, in which a personalized message is applied to a label affixed to an ornament.

FIG. 7 illustrates a rear elevational view of the embodiment of FIG. 6.

FIG. 8 illustrates a plan view of a die-cut sheet including multiple wave-shaped labels used to add personalized messages to decorative ornaments of the present invention.

FIG. 9 illustrates a plan view of a die-cut sheet including a single wave-shaped label used to add personalized messages to decorative ornaments of the present invention.

FIG. 10 illustrates a plan view of a die-cut sheet including multiple oval-shaped labels used to add personalized messages to decorative ornaments of the present invention.

FIG. 11 illustrates a plan view of a die-cut sheet of a single oval-shaped label used to add personalized messages to decorative ornaments of the present invention.

FIG. 12 schematically illustrates a computerized system for applying personalized messages to labels that may be affixed to embodiments of the invention.

FIG. 13 illustrates a front elevation view of another embodiment.

FIG. 14 illustrates a front elevation view of another embodiment.

FIG. 15 illustrates a front elevation view of another embodiment.

FIG. 16 illustrates a front elevation view of another embodiment.

FIG. 17 illustrates a front elevation view of another embodiment.

FIG. 18 illustrates a front elevation view of another embodiment.

### DETAILED DESCRIPTION OF THE INVENTION

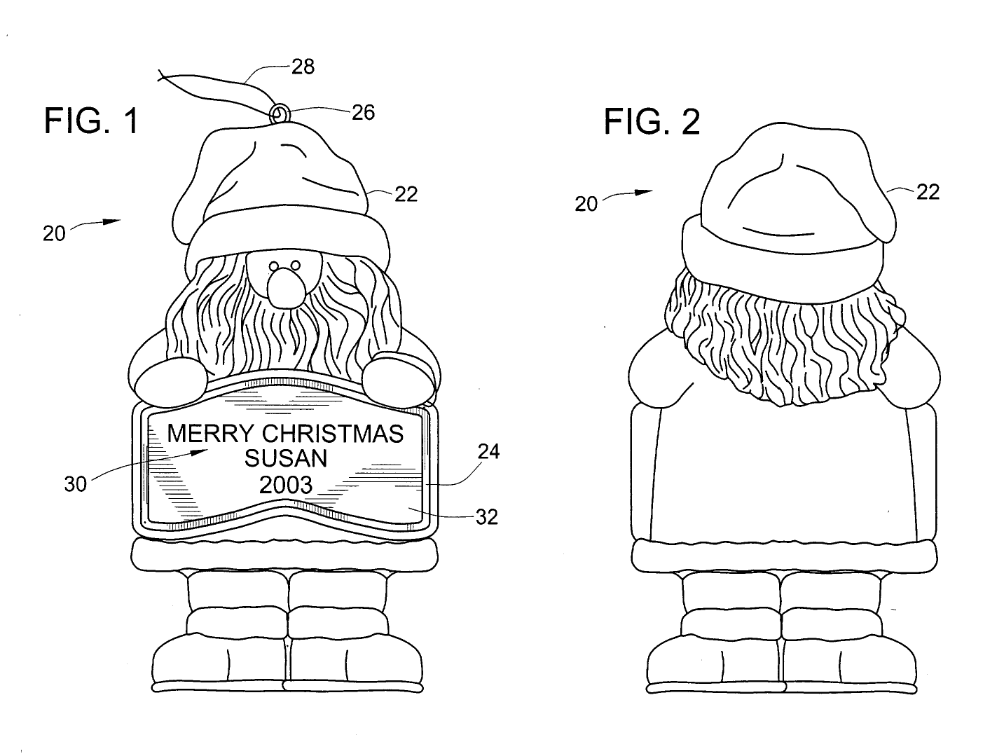

In the embodiment of FIG. 1, a decorative ornament 20 includes a body 22 having a dedicated message surface 24, where a personalized message may be displayed. FIG. 2 illustrates the back side of the body 22 of the ornament 20. In this embodiment, the body 22 is in the shape of a traditional Christmas-themed figurine. Of course, the body 22 of this embodiment is not limited to the shape described. In keeping with the inventive scope, the body 22 can take any decorative shape. For example, it may be shaped as a figurine representing a particular occasion, holiday or seasonal theme, sport theme or other theme, such as a wedding, childbirth, Christening, graduation, Halloween, Thanksgiving, Easter, Channukah, spring, summer, fall, winter, football, baseball, basketball, soccer ball, golf ball, golf club, running shoe, basketball shoe, football cleat, skis, skates, or other shapes.

To facilitate efficient and cost-effective production, the body 22 of this embodiment may be fabricated of a plaster or ceramic material. It is to be appreciated, though, that the material used to fabricate the body 22 is not limited to plaster or ceramic. In contrast, many types of materials may be used in fabricating the body 22. For example, it may be fabricated of wood, plastic, metal, polyresin, fabric, ceramicor any other material that may be formed in the desired decorative shape.

The body 22 of this embodiment may also include a loop, or hook 26 for hanging the body 22. A short piece 28 of string, twine, wire, ribbon or other typical ornament-hanging material may pass through the loop, or hook 22, to facilitate hanging the decorative ornament 20 in its desired location. In this fashion, the ornament 20 may be hung from a hook or nail, a Christmas tree, or a mantelpiece, among other locations and methods for hanging decorative ornaments.

Advantageously, the present invention permits a retailer to apply a personalized message to an ornament at the point-of-sale of the ornament, in response to spontaneous purchaser demand. To allow a retailer to print or otherwise apply a personalized message to the ornament 20, the body 22 of this embodiment may include a message surface 24. The message surface 24 may simply constitute a portion of the body 22, suitable for bearing a customized or personalized message. The message surface 24 may be molded, pressed, carved, chiseled, or otherwise integrated into the body 22. In one embodiment, the personalized message may be printed or otherwise applied to a label 32 that is affixed to the message surface 24. It is to be appreciated that a personalized message according to the present invention may include text, but is not limited thereto. On the other hand, the message may include various symbols, such as, for example, smiley faces, religious symbols, traditional holiday symbols, heart or shamrock. In addition, the message may include the year.

As illustrated in FIG. 1, the message surface 24 may have a decorative and appealing wave-shape. However, in keeping with the inventive scope, the invention contemplates various shapes of the message surface 24. For example, the message surface 24 may be round, square, rectangular, trapezoidal, triangular, obround, oval, semicircular, star-shaped, cloud-shaped, heart-shaped, tree-shaped or any other shape. In addition, the message shape may be determined by the ornament design.

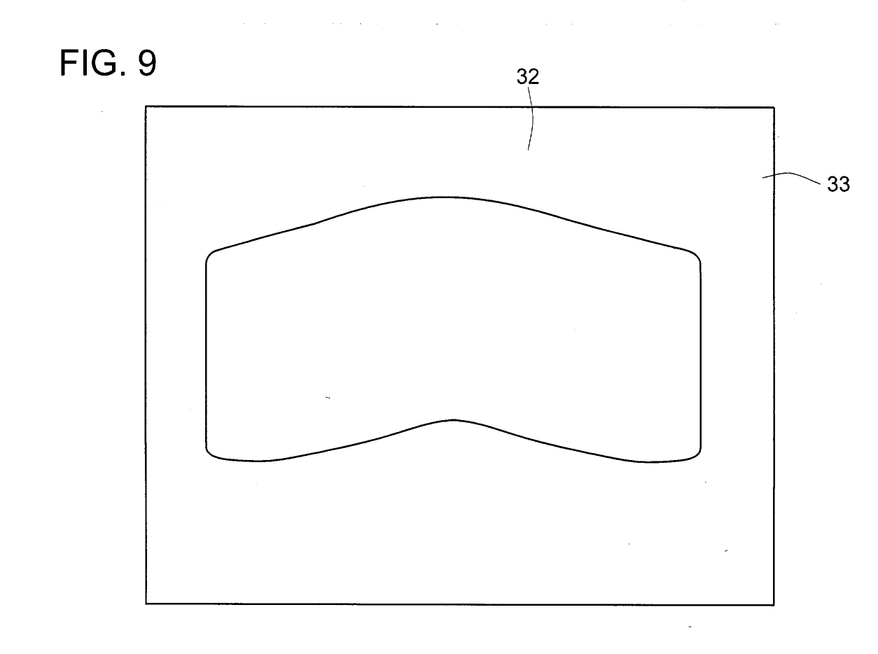

The message surface 24 is of suitable flatness and smoothness for the affixation of such a label 32 bearing a personalized message 30. The label 32 of this embodiment may be of the self-stick, adhesive-backed type. Such a label may be affixed to the message surface 24 simply by removing a protective backing from the backside of the label 32, thus exposing the adhesive, and pressing the adhesive to the message surface 24. Of course, in keeping with the inventive scope, other attachment methods may be used to affix the label 32 to the message surface 24. For example, the label 32 may include a water-activated gummed adhesive. In an embodiment of the invention, the label 32 may be die cut into a single label sheet 33, as illustrated in FIG. 9.

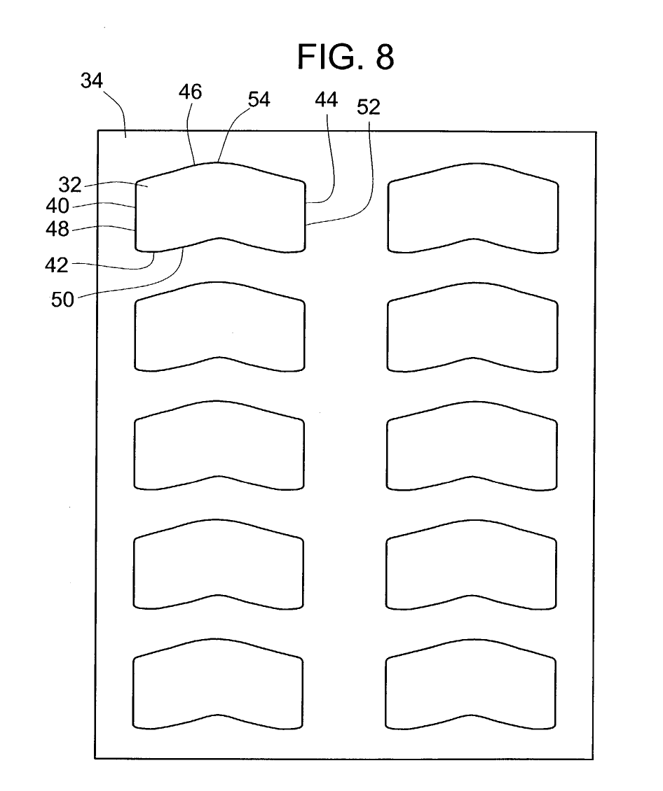

Applying a personalized message 30 to a label 32 that is affixed to the body 22 of an ornament 20 advantageously provides for quick, completely versatile personalization of the ornament 20. In order to provide even greater efficiency and convenience, another embodiment may include a die-cut sheet 34 of labels 32, as illustrated in FIG. 8. The die-cut sheet 34 may be utilized with adhesive-backed labels 32, as discussed above. The die-cut sheet 34 may include cut lines 40, 42, 44, 46 in a pattern defining the edges 48, 50, 52, 54 of the labels 32 such that individual labels 32 may be removed from the sheet 34. Thus, a retailer may print or otherwise prepare a number of labels 32 bearing personalized messages on such a die-cut sheet 34, before removing individual labels from the sheet 34 and affixing them to the body 22 of an ornament 20. As a result, a retailer may generate a new label 32 for each individual customer, or he may generate multiple labels 32 bearing a particular name or greeting in advance, for affixation to ornaments 20 upon customer demand. Either method affords a retailer great flexibility in producing personalized ornaments in response to customer demand. A retailer can thus avoid having to keep a large number of different personalized ornaments on hand, particularly those for which there ultimately proves to be little demand. In addition, the retailer can balance his or her inventory by removing the original labels with low demand messages from the ornaments and apply new labels with high demand messages to the same ornaments to meet customer demand.

The utility of the die cut sheet 34 may be further enhanced by the use of a computerized system for generating labels with personalized messages, as illustrated in FIG. 14. Such a system may include a computer system 60 and a printer 62. In addition, other devices may be used to apply a personalized message to the label. For example, an ink-jet system or other type of spraying system may be used, or a mechanical printhead or stylus may be employed, in keeping with the inventive scope. In another embodiment, a retailer may use a personal computer running consumer word-processing software to generate labels individually, or by the sheet. The labels may be generally available standard label sheets or the labels may be other than a standardized shape and size, such as, a sheet 34 of wave-shaped labels, as shown in FIG. 8. An embodiment of the present invention may thus include software instructions that direct a computer to print such labels on the sheet 34 of FIG. 8. These instructions may be loaded onto the computer processor via CD-ROM 64, or downloaded from the Internet 66, among various methods. Of course, it is to be appreciated that many shapes of labels are contemplated within the inventive scope. For example, different embodiments may contemplate round, square, rectangular, trapezoidal, triangular, obround, semicircular, star-shaped, or other-shaped labels. Also, the customer may order a label with a custom shape. The labels with the custom shape are generated and sent to the store or the customer. Moreover, the labels for use with computerized printing systems are not limited to sheets with multiple labels. In contrast, the labels may be individually provided and printed. Additionally, the actual personalized messages may be completely discretionary to the purchaser, or the software may include a selection of messages for a retailer to offer a purchaser to choose from. The software package may be Microsoft Excel, Microsoft Word, other commercially available software packages, or custom software packages.

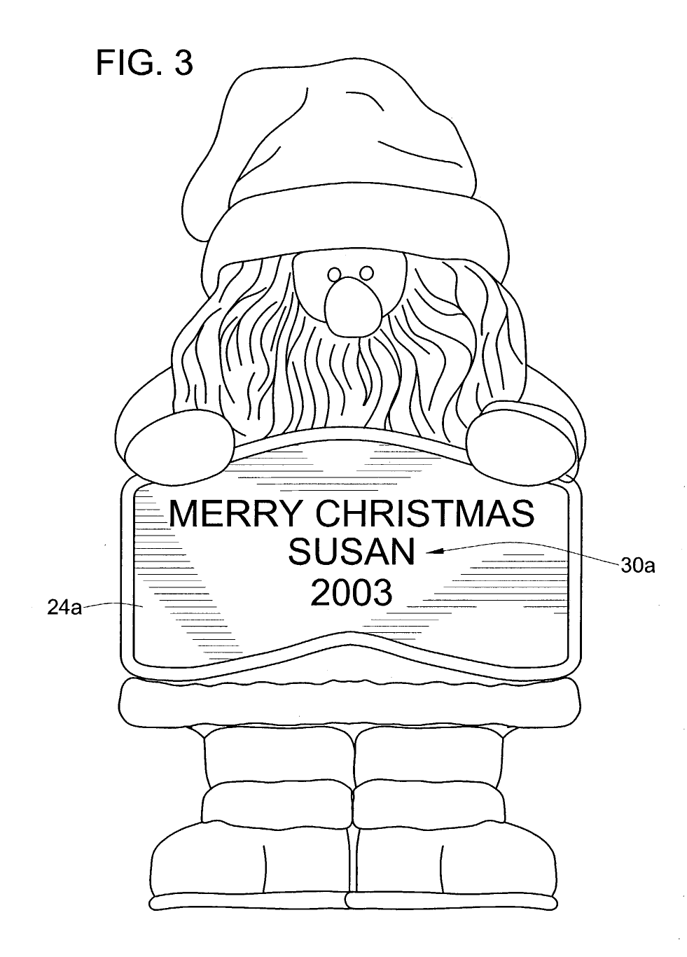

It is also to be appreciated that a computerized printing system may include a print mechanism specially configured to print directly on ornaments of various shapes, rather that printing on labels that are affixed to the ornament, as shown in FIG. 3 wherein the message 30A is applied directly to the message surface 24A.

Thus, the invention provides a system for a retailer to apply a personalized message to an ornament at the point-of-sale, in response to spontaneous customer demand.

In addition to the embodiments directed at retailers, an embodiment of the invention may be directed at purchasers, as a kit which may include the labels and ornaments. In addition, the kit may include software. In this embodiment, the software may include instructions for a computerized system to generate individual labels or sheets of labels bearing a personalized message, in conjunction with, or independently of popular consumer software packages. The actual personalized messages may be completely discretionary to the purchaser, or the software may include a selection of messages for the purchaser to choose from. This software may be installed onto the computer processor of this embodiment via CD-ROM 64 or downloaded from the Internet 66. Further, the software may direct the computerized system to generate labels individually, or by the sheet, as described above. As a result, a purchaser may generate ornaments bearing personalized messages, after purchasing the software, ornament(s) and label(s), either individually, or as a kit.

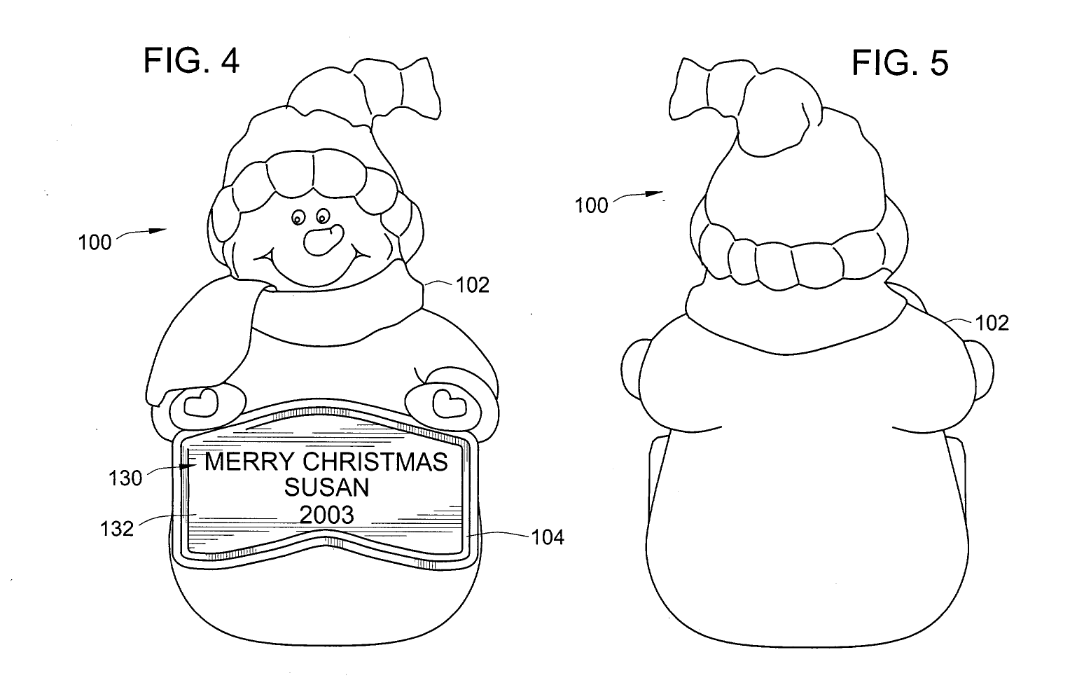

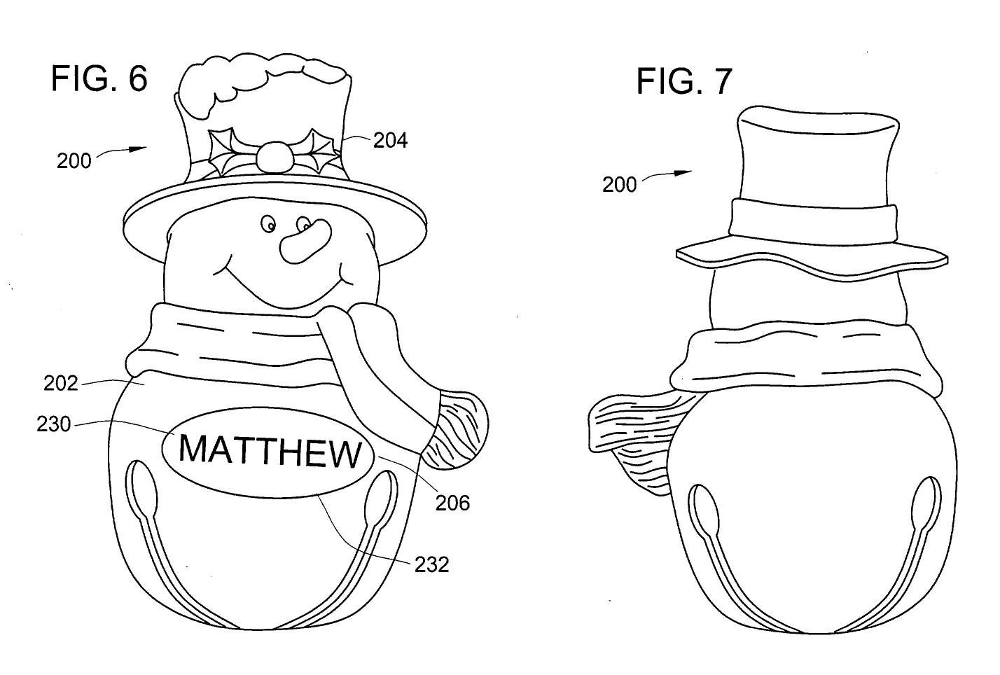

In keeping with the inventive scope, FIG. 4 illustrates another embodiment of the present invention. In this embodiment, the ornament 100 has a body 102 in the shape of a snowman character. The body 102 includes a message surface 104, to which personalized message 130 may be printed or otherwise applied to the label 132. FIG. 5 illustrates the backside of the body 102 of the ornament 100. In the embodiment of FIG. 4, the message surface 104 is configured to receive a wave-shaped label 132 including a personalized message 130, as described above. Of course, it is to be appreciated that the labels and message surfaces of the invention are not limited to a wave-shape. In contrast, the invention contemplates embodiments in which the label and the message surface may be round, square, rectangular, trapezoidal, triangular, obround, oval, semicircular, star-shaped, cloud-shaped, heart-shaped, tree-shaped or any other shape, in keeping with the inventive scope.

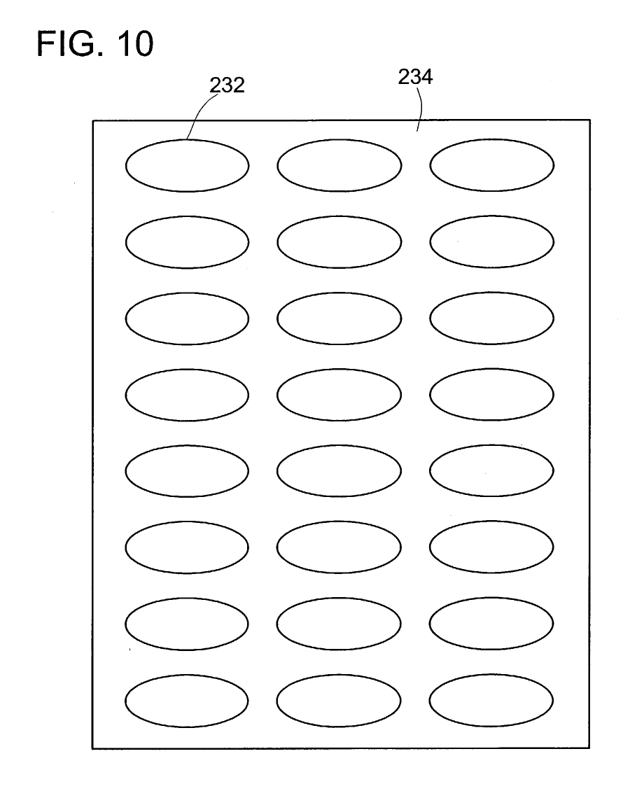

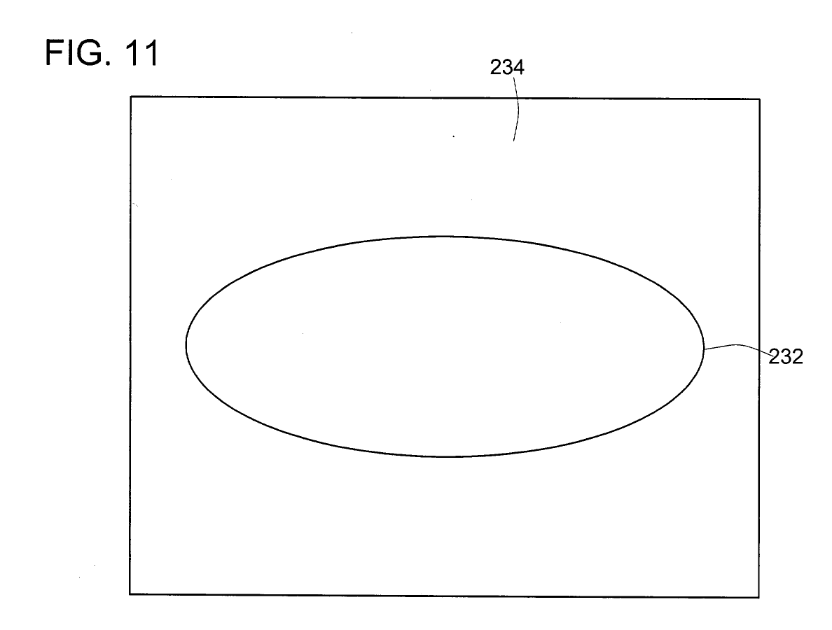

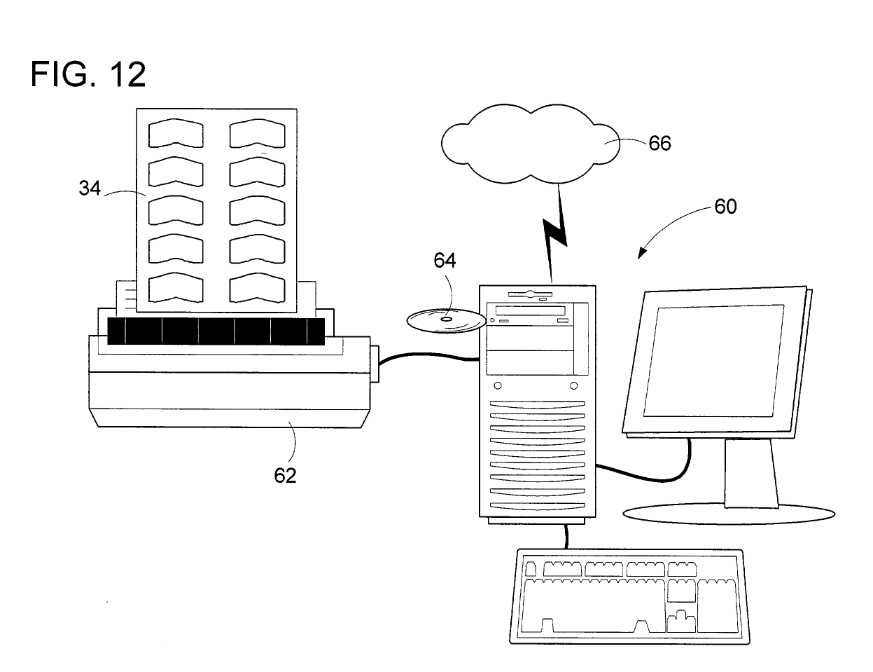

FIG. 6 illustrates another embodiment of the present invention. In this embodiment, the ornament 200 includes a bell portion 202 and a body portion 204 shaped as a holiday character. FIG. 7 illustrates the rear view of the ornament 200 of this embodiment. As illustrated in FIG. 6, the bell portion 202 of the ornament 200 may include a message surface 206 where a personalized message 230 may be applied to a label 232 that is affixed to the message surface 206. The label 232 of this embodiment may be oval-shaped. To provide an attractive appearance, the personalized message 230 of this embodiment may be printed on a clear label 210. As described above, the label 210 may be printed on adhesive label sheets that are self-adhesive, or that require additional steps by the user for application. Moreover, the each label 210 may be individually die-cut, or multiple labels may be die-cut into a label sheet. FIG. 10 illustrates a die-cut sheet 234 of multiple oval-shaped labels. FIG. 11 illustrates a single oval-shaped label 232 die-cut into a sheet 234. In keeping with the inventive scope, the label 232 may take various shapes, for example, round, square, rectangular, trapezoidal, triangular, obround, oval, semicircular, star-shaped, or any other shape.

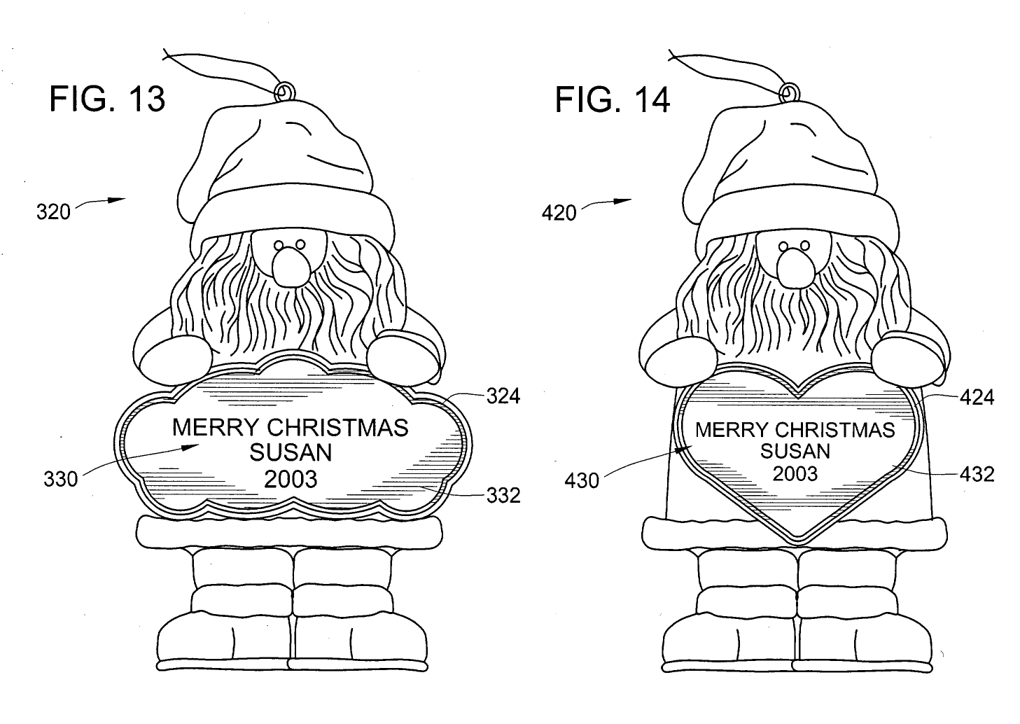

FIG. 13 illustrates another embodiment of the present invention. In this embodiment, the ornament 320 includes a message surface 324, a message 330 and a label 332. The message surface 324 has a cloud shape. In addition, the label 432 has a cloud shape. However, in other embodiments, the message surface 324 may be cloud-shaped and the label may have a different shape. Also, in other embodiments, the label 324 may be cloud shaped and the message surface may have a different shape.

FIG. 14 illustrates another embodiment of the present invention. In this embodiment, the ornament 420 includes a message surface 424, a message 430 and a label 432. The message surface 424 has a heart shape. In addition, the label 432 has a heart shape. However, in other embodiments, the message surface 424 may be heart-shaped and the label may have a different shape. Also, in other embodiments, the label 424 may be heart shaped and the message surface may have a different shape.

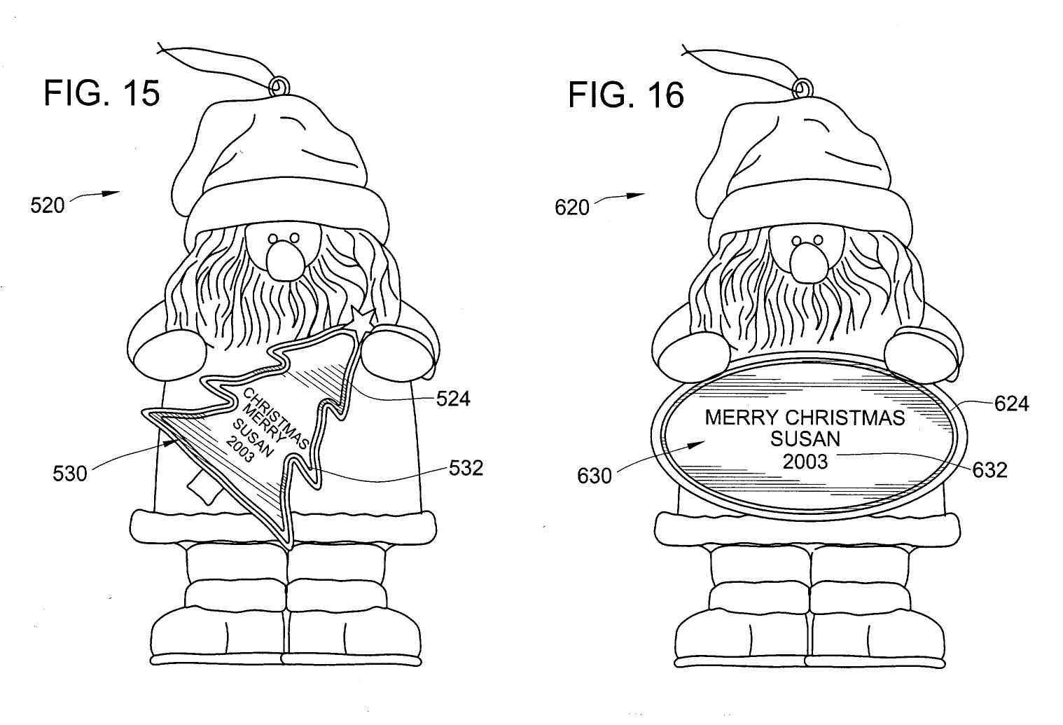

FIG. 15 illustrates another embodiment of the present invention. In this embodiment, the ornament 520 includes a message surface 524, a message 530 and a label 532. The message surface 524 has a tree shape. In addition, the label 532 has a tree shape. However, in other embodiments, the message surface 524 may be tree-shaped and the label may have a different shape. Also, in other embodiments, the label 524 may be tree shaped and the message surface may have a different shape.

FIG. 16 illustrates another embodiment of the present invention. In this embodiment, the ornament 620 includes a message surface 624, a message 630 and a label 632. The message surface 624 has an oval shape. In addition, the label 632 has a oval shape. However, in other embodiments, the message surface 624 may be oval-shaped and the label may have a different shape. Also, in other embodiments, the label 624 may be oval shaped and the message surface may have a different shape.

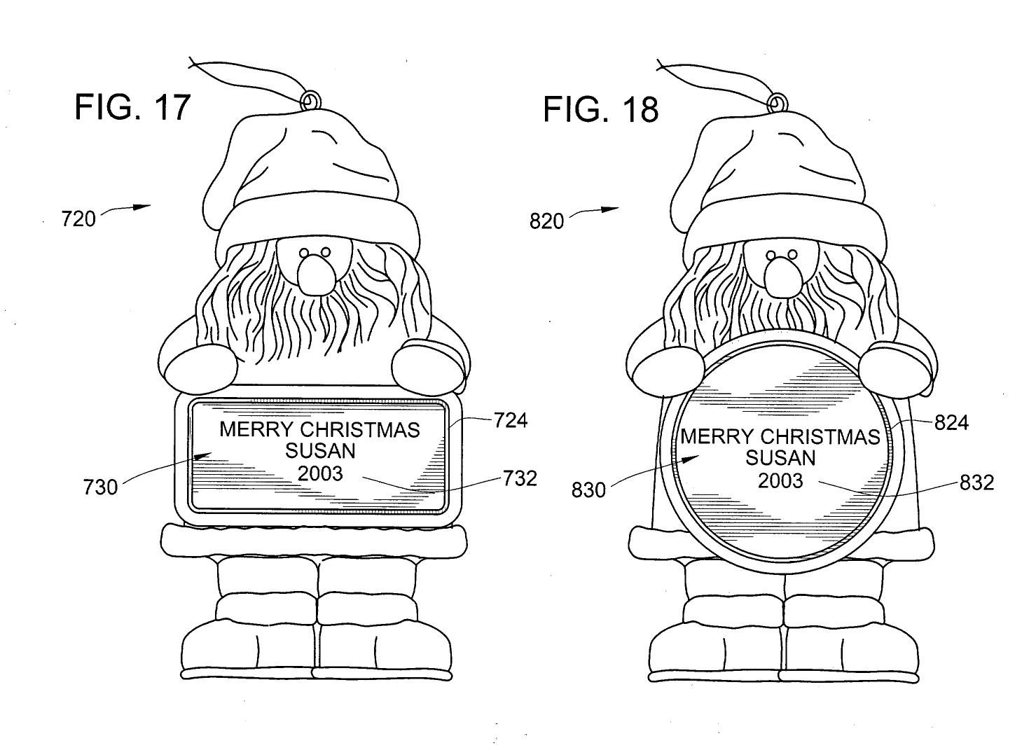

FIG. 17 illustrates another embodiment of the present invention. In this embodiment, the ornament 720 includes a message surface 724, a message 730 and a label 732. The message surface 724 has a rectangle shape. In addition, the label 732 has a rectangle shape. However, in other embodiments, the message surface 724 may be rectangle-shaped and the label may have a different shape. Also, in other embodiments, the label 724 may be rectangle shaped and the message surface may have a different shape.

FIG. 18 illustrates another embodiment of the present invention. In this embodiment, the ornament 820 includes a message surface 824, a message 830 and a label 832. The message surface 324 has a round shape. In addition, the label 832 has a round shape. However, in other embodiments, the message surface 824 may be round-shaped and the label may have a different shape. Also, in other embodiments, the label 824 may be round shaped and the message surface may have a different shape.

Thus, the invention provides for a decorative ornament that may include a personalized message that is printed or applied at the point-of-sale, or by a purchaser after purchase. The method of making such an ornament comprises the following steps. First, a purchaser selects an ornament to be personalized. Next, the retailer or purchaser prints or otherwise applies a personalized message to a label and applies the label to a message surface on the ornament. A retailer may print the label before or after a purchaser selects the ornament. In alternate embodiments, a retailer or purchaser may use a computerized system to apply a personalized message directly onto the body of the ornament, or the system may generate labels with personalized messages. The labels may then be affixed to ornaments.

Thus, the invention provides for personalized decorative ornaments prepared at the point-of-sale, or by the purchaser after purchase, and an efficient, cost-effective method for making the same.

All references, including publications, patent applications, and patents, cited herein are hereby incorporated by reference to the same extent as if each reference were individually and specifically indicated to be incorporated by reference and were set forth in its entirety herein.

The use of the terms “a” or “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to”,) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A decorative ornament that includes a personalized message, the ornament comprising:
a message surface where the personalized message is applied; and
a label bearing the personalized message, the label has an adhesive surface, the label being affixed to the message surface of the ornament at the point-of-sale of the ornament.

2. The ornament of claim 1, wherein the label is a self-adhesive label.

3. The ornament of claim 1, wherein the label includes a gummed, water-activated adhesive for affixing the label to the ornament.

4. The ornament of claim 1, wherein the label is part of a sheet of labels, the sheet being die-cut to define the labels.

5. The ornament of claim 1, wherein the personalized message is applied to the label at the point-of-sale of the ornament.

6. The ornament of claim 5 wherein the message is applied by using a computerized system to apply the message to the label.

7. The ornament of claim 1, wherein the label is of the same shape as the message surface.

8. The ornament of claim 7, wherein the message surface and the label are of the same shape, the shape being selected from the group consisting of: round, rectangular, oval, wave-shaped, cloud-shaped, heart-shaped, or tree-shaped.

9. The ornament of claim 1, the ornament further including a loop for hanging the ornament.

10. The ornament of claim 9, the ornament further including a means for hanging the ornament by the loop.

11. The ornament of claim 1, wherein the personalized message comprises text only.

12. A decorative ornament that includes a personalized message, the ornament comprising:
a message surface where personalized message is applied; and
a label bearing the personalized message, the label has an adhesive surface, the label being affixed to the message surface of the ornament after its purchase.

13. The ornament of claim 12, wherein the personalized message is applied to the label after its purchase.

14. The ornament of claim 12, wherein the message is applied by using a computerized system to apply the message to the label.

15. The ornament of claim 12, wherein the message surface and the label are of the same shape, the shape being selected from the group consisting of round, rectangular, oval, wave-shaped, cloud-shaped, heart-shaped, or tree-shaped.

16. The ornament of claim 12, wherein the label is a self-adhesive label.

17. The ornament of claim 12, wherein the label includes a gummed, water-activated adhesive for affixing the label to the ornament.

18. The ornament of claim 12, wherein the label is part of a sheet of labels, the sheet being die-cut to define the edges of the labels.

19. The ornament of claim 12, the ornament further including a loop for hanging the ornament.

20. The ornament of claim 19, the ornament further including a means for hanging the ornament by the loop.

21. A method of applying a personalized message to a decorative ornament at the point of sale of the ornament, the method comprising the steps of:
providing an ornament that includes a message surface;
providing a label with an adhesive surface;
preparing the label with a personalized message; and
applying the label to the message surface.

22. The method of claim 21, wherein the step of preparing a label with a personalized message further includes the steps of inputting the personalized message into a computerized system that generates the label.

23. The method of claim 22, wherein the computerized system includes a printer that prints the message onto the label.

24. The method of claim 21, wherein the label is a self-adhesive label.

25. The method of claim 21, wherein the label includes a gummed, water-activated adhesive for affixing the label to the ornament.

26. The method of claim 21, wherein the label is part of a sheet of labels, the sheet being die-cut to define the edges of the label.

27. The method of claim 21, wherein the label is of the same shape as the message surface.

28. The method of claim 21, wherein the shape of the message surface and the label is selected from the group consisting of: round, rectangular, oval, wave-shaped, cloud-shaped, heart-shaped or tree-shaped.

29. The method of claim 21, the ornament further including a loop for hanging the ornament.

30. The ornament of claim 29, the ornament further including a means for hanging the ornament by the loop.

31. The method of claim 21, wherein the personalized message comprises only text.

32. A decorative ornament that includes a personalized message, the ornament comprising:
a message surface where the personalized message is applied; and
a label bearing the personalized message, the label being affixed to the message surface of the ornament wherein the message is applied by using a computerized system to apply the message to the label.

33. A method of applying a personalized message to a decorative ornament at the point of sale of the ornament, the method comprising the steps of:
providing an ornament that includes a message surface;
providing a label;
preparing the label with a personalized message by using a computerized system that generates the label; and
applying the label to the message surface.

34. A decorative ornament that includes a personalized message, the ornament comprising:
a message surface where the personalized message is applied; and
the message is applied by using a computerized system to apply the message to the ornament.

35. The ornament of claim 34, wherein the personalized message is applied to the ornament, at a point-of-sale of the ornament.

36. The ornament of claim 34, wherein the personalized message is applied to the ornament after the purchase of the ornament.

37. A method of applying a personalized message to a decorative ornament, the method comprising the steps of:
providing an ornament that includes a message surface;
providing a computerized system to apply the personalized message to the ornament; and
applying the personalized message to the ornament.

38. The method of claim 37, wherein the step of preparing a label with a personalized message further includes the step of inputting the personalized message into the computerized system that generates the label.

39. The method of claim 38, wherein the computerized system includes a printer that prints the message onto the label.

40. The ornament of claim 37, wherein the personalized message is applied to the ornament, at a point-of-sale of the ornament.

41. The ornament of claim 37, wherein the personalized message is applied to the ornament after the purchase of the ornament.
